(19) United States
(12) Patent Application Publication
(10) Pub. No.: US 2024/0378557 A1
(43) Pub. Date: Nov. 14, 2024

(54) DIGITAL DOCUMENT AND NETWORK MANAGEMENT (DDMS)

(71) Applicant: DISH Network L.L.C., Englewood, CO (US)

(72) Inventors: Media JOHNSEN, Denver, CO (US); Marc ROUANNE, Cherry Hills Village, CO (US); Robert J. KIERZYK, Littleton, CO (US); Ahmed ALKARBOLY, Denver, CO (US); Hannah MENDOZA, Denver, CO (US); Talia ZALESNE, Louisville, CO (US); Neha YALAMANCHI, Littleton, CO (US); Akhil Teja KANUGOLU, Denver, CO (US); Rishvita BHUMIREDDY, Highlands Ranch, CO (US); Dheeraj Sai CHAVA, Highlands Ranch, CO (US)

(73) Assignee: DISH Network L.L.C., Englewood, CO (US)

(21) Appl. No.: 18/315,416

(22) Filed: May 10, 2023

(51) Int. Cl. G06Q 10/10; G06Q 30/01

(52) U.S. Cl. CPC G06Q 10/103; G06Q 30/01

(57) ABSTRACT

Digital document and network management (DDMS) system includes digitizing a document into a standard digital format, and storing the digitized document in an authoritative CTR governance database. The DDMS system also includes organizing a plurality of technical requirements extracted from the digitized contract within the authoritative CTR governance database, and linking a plurality of network function test cases to the plurality of technical requirements. Furthermore, the DDMS system includes storing a plurality of results in the authoritative CTR governance database.

### FIELD

The present invention generally relates to digitizing documents and testing requirements identified within the digitized document on a telecom network.

### BACKGROUND

Existing solutions for document and network management are manual, disaggregated and reactive. Currently, there is no end-to-end solution, which automatically extracts requirements from documents, creates databases and triggers automated testing of a network. In addition to the above all finance and accounting related actions related to deliverables, quality of the network and more are mainly executed manually.

Accordingly, an improved and/or alternative approach may be beneficial.

### SUMMARY

Certain embodiments of the present invention may provide solutions to the problems and needs in the art that have not yet been fully identified, appreciated, or solved by current application and network compliance testing technologies, and/or provide a useful alternative thereto. For example, some embodiments of the present invention pertain to digitizing a document and analyzing and/or crawling a telecom network to verify if requirements in the digitized documents are fulfilled.

In an embodiment, a computing system includes memory storing computer program instructions and at least one processor configured to execute the computer program instructions. The computer program instructions are configured to cause the at least one processor to execute digitizing a document into a standard digital format, storing the digitized document in an authoritative CTR governance database, and organizing a plurality of technical requirements extracted from the digitized contract within the authoritative CTR governance database. The computer program instructions are further configured to cause the at least one processor execute linking a plurality of network function test cases to the plurality of technical requirements, and storing a plurality of results in the authoritative CTR governance database.

In another embodiment, a non-transitory computer-readable medium comprising a computer program. The computer program is configured to cause at least one processor to execute digitizing a document into a standard digital format, storing the digitized document in an authoritative CTR governance database, and organizing a plurality of technical requirements extracted from the digitized contract within the authoritative CTR governance database. The computer program is further configured to cause at least one processor to execute linking a plurality of network function test cases to the plurality of technical requirements, and storing a plurality of results in the authoritative CTR governance database.

In yet another embodiment, a computer-implemented method includes digitizing a document into a standard digital format, storing the digitized document in an authoritative CTR governance database, and organizing a plurality of technical requirements extracted from the digitized contract within the authoritative CTR governance database. The computer-implemented method also includes linking a plurality of network function test cases to the plurality of technical requirements, and storing a plurality of results in the authoritative CTR governance database.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a database (or bucket), according to an embodiment of the present invention.

FIG. 2 is a diagram illustrating a DDMS architecture, according to an embodiment of the present invention.

FIG. 3 is a flow diagram illustrating a method for determining how a network should be operating or how the network should be deployed using a digitized document, according to an embodiment of the present invention.

FIG. 4 is an architectural diagram illustrating a computing system configured to digitize a document and test telecom network performance based on the digitized document, according to an embodiment of the present invention.

FIG. 5 illustrates a communication diagram between the JSON file, for example, and the project management tool, according to an embodiment of the present invention.

FIG. 6 is a flow diagram illustrating a process for digitizing a contract on the backend, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to the digitization of documents containing parameters for how the network should be operating or how the network should be deployed. The digitized document is placed in an authoritative datastore (e.g., the authoritative Contributor (CTR)>governance DB). From there, test cases are built or created from the requirements that are now in the authoritative datastore. The test cases are then executed to test the network for specific requirements and the information (or test results) is written into the authoritative datastore. This allows for a matrix of technical requirements for each contract to be considered, and determine how the application or service is behaving on the network.

Under Technical Requirements Table (a), requirements (e.g., technical) in the contract are structured in table and matrix format. For each contract at any given time, the matrix may catalog the expectation of the application or technology deployed on a network. The tables allow for data feedback on those technical requirements.

The technical requirements table is a part of the authoritative data store that orchestrates and organizes the relationships between technical requirements, the test cases for those requirements, and the network functions they correlate to. This is also the core of what enables tracking and compliance of technical requirements.

Under CTR Tables (b), CTR information is organized in a table format.

The CTR table is a part of the authoritative datastore that keeps entities deploying on the network organized.

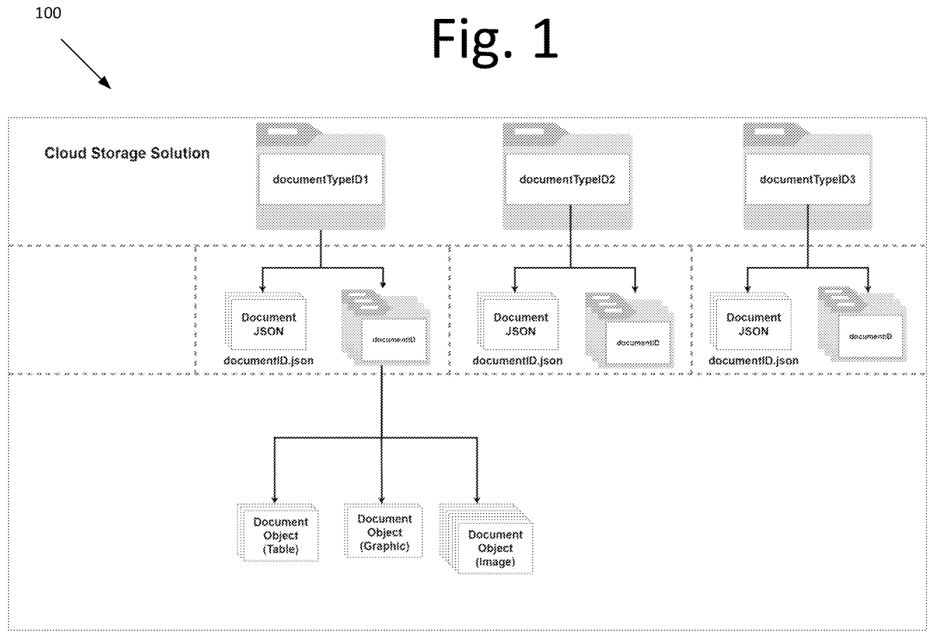

Legal Tables (c) includes tables used for pointing to documents, as shown in FIG. 1. For example, the documents identified in Legal Tables (c) point to digitized version in the shown in FIG. 1. In short, Legal Tables (c) are more of a relational database.

FIG. 1 is a diagram 100 illustrating a database (or bucket), according to an embodiment of the present invention. For purposes of explanation, Storage includes folders that contain data; similar to a File Explorer™, but on the cloud. In this embodiment, a folder dedicated to each document type, and JavaScript Object Notation (JSON) files or Yet Another Markup Language (YAML) files in this document are stored in each folder, which organize the digitized document type.

Let's say for example a CTR contract is accessed for any contributor and the contract (or document) is digitized. The digitized document (i.e., the JSON file) is then stored in a document type ID 2 folder, and another folder (i.e., a subfolder) is created. This other folder (or folders) may store any assets or diagrams extracted from the contract.

The reason for this configuration is, there may be application packages that tabularizes the digitized documents (or files). Simply put, the open source packages take the digitized document from an unstructured format to a structured format (i.e., table format), thereby allowing for queries to be run against the tables. This allows for efficient queries to be run against the tables.

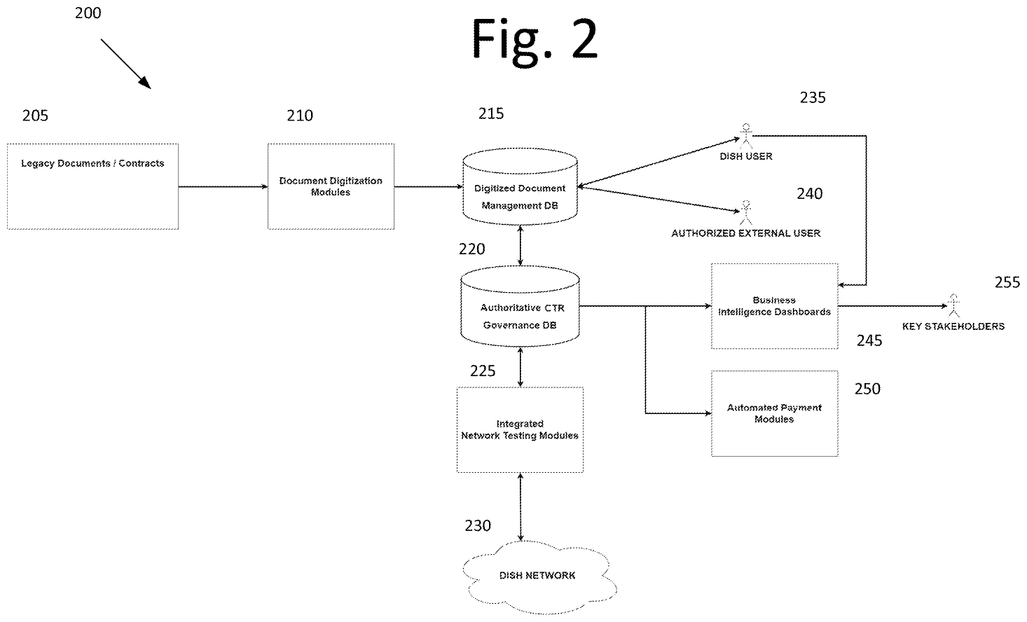

FIG. 2 is a diagram illustrating a DDMS architecture 200, according to an embodiment of the present invention. In this embodiment, a legal document (or contract) 205, which may be in MS Word™ or PDF™ format or other file types mentioned as PDF in the document, is accessed and digitized by one or more document digitization modules 210. The contract, which is in PDF format, is processed converting the contract to a digitized format. This digitized contract allows for extraction of phrases that are important with respect to the section the phrases are under. The extracted phrases may then be added to a JSON file and automate the process of uploading the phrases to a tracking software. The tracking software that may be used includes but not limited to Jira and MS Project.

For purposes of explanation only, a digitized document is a JSON structure that organizes extracted information from the legal document (or contract). The idea is to pull out the metadata in the contract. This metadata may include the partners in the contract, the terms, effective date, and end date. By digitizing all of the sections and subsections, each paragraph, along with the content, is placed in another format that is in a JSON readable format. Further, nested under each paragraph, there may be a requirement section. In some embodiments, there may be a repository of requirement types. This may include a due date, a payment milestone, etc. For example, if a requirement is present within the paragraph, a ‘1’ will be listed to identify that there is a requirement present. Under this, there may be requirement types and any relevant information (e.g., deadlines) for the requirement.

In terms of pre-processing, the code (or algorithm) provides a user interface for a user 235 or external user 240 to login and upload a file. Additionally, user 235 or external user 240 may identify the specific phrases within the contract, the associated project, etc. Once the information is submitted, the code is executed on the back end. In certain embodiments, there are two aspects that are running at the same time. First part is creating the JSON file, which allows for the digitized document. The second part is the uploading (including extracting of the data from the document) of the JSON file into the tracking software.

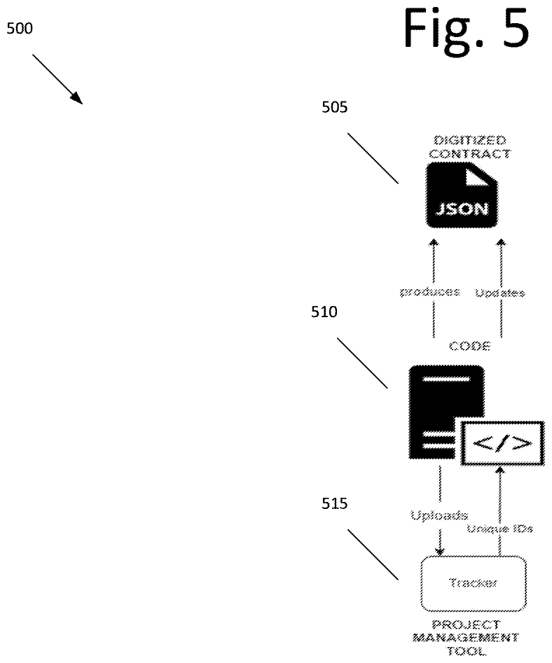

Once this is complete, all of the ticket numbers associated with the tickets created for the paragraphs in the contracts are also added back into the JSON, YAML, or other file types. This way, the ticket numbers can be tracked within the file. See, for example, FIG. 5, which illustrates a communication diagram 500 between the JSON file 505, for example, and project management tool 515, according to an embodiment of the present invention. In this embodiment, a code 510, which is embedded in a central repository, uploads deliverables, technical specification and any information that needs to be tracked. In response, project management tool 515 generates unique IDs. In some embodiments, all deliverables, technical specification, and any information that needs to be tracked may have a unique ID. Using the unique IDs, code 510 is executed causing the JSON™ file to be updated with new information found in the document. In some embodiments, code 510 may create a new JSON file if required.

For uploading a digitized contract, including all extracted materials, into a tracking software, an issue is created in Jira for each section extracted from the contract. Although Jira is discussed in this embodiment, any tracking software may be used. Each issue being created uses the section name extracted directly from the contract and the unique section ID programmatically assigned to the section. The algorithm may then write back the issue IDs created in the tracking software so that the subsection level of the JSON is updated and uploaded into the software with the correct dependencies.

In some embodiments, the digitized version of the document may also be downloaded, if necessary. This digitized document is easily indexable; meaning that a query can be run to return all relevant information for a specific attribute in a JSON file. For example, if all requirements for a specific type of attribute or component across multiple vendors were needed; because the document is digitized in an indexable format, the query can return the relevant information about specifications and timelines.

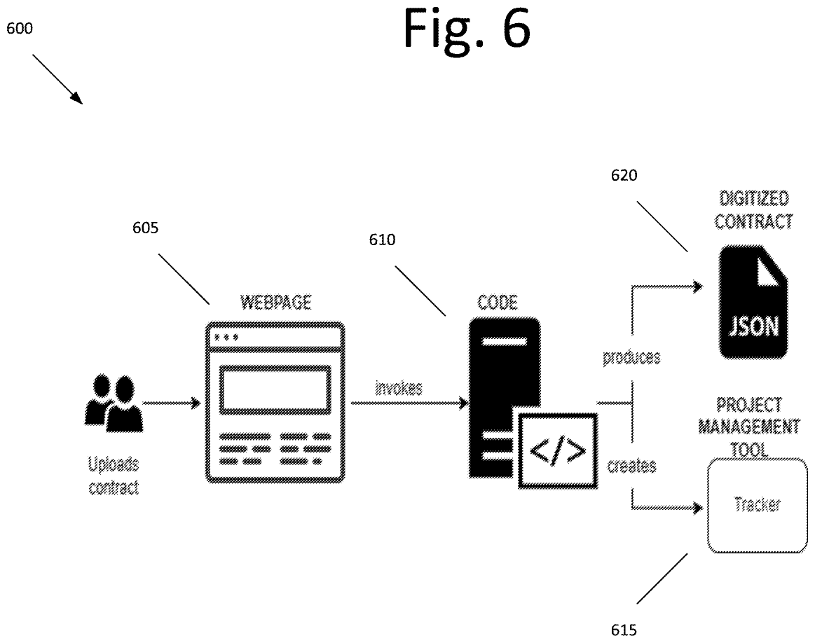

FIG. 6 is a flow diagram illustrating a process 600 for digitizing a contract on the backend, according to an embodiment of the present invention. In this embodiment, a user uploads a contract document via user interface (UI) 605. Upon loading, a machine learning (ML) model (or code) 610 is invoked or triggered. This backend ML model (or code) 610 automatically extracts the content from the document in a digitized format and uploads the extracted content in project management tool 615 to be tracked. In addition, ML model 610 produces a digitized contract from the extracted content in JSON format 620.

In some embodiments, ML modules are used to extract data from the document. Since there may be keywords that differ from one document to another, the words that are used to imply deliverable may be different. With natural language processing (NLP), it may be easier to predict or find minute changes in jargon.

Another way ML modules may be used is for the extraction of metadata. By building ML models that contain historical metadata, the ML modules may extract the metadata from the document.

A digitized document management database 215 may store the digitized document, which may be accessed by an internal user 235, authorized external user 240, and/or authoritative CTR governance database 220. For example, an internal user 235 or an authorized external user 240 may access the digital contract to pull technical requirements mentioned and the agreed upon level of commitment by both parties.

Authoritative CTR governance database 220 may communicate with the digitized document management database 215, and may store requirements extracted from the digitized contract. This digitized document management database 215 stores all information mentioned in the contract including, but not limited to, deliverables, technical requirements, deadlines, financial commitments, all clauses, dates and any information provided in a contract.

Integrated network testing modules 215 may include test cases, which are built around requirements within authoritative CTR governance database 220. In some embodiments, the test cases may be executed internally or externally to test network 230. By way of example, an internal test may be described as testing the latency of a point to point connection. An external test may be described as testing being done by external partners, which will provide information on the performance of the network.

Based on the result of the test case, integrated network testing modules 225 may be in communication with authoritative CTR governance database 220, and may write the results back to authoritative CTR governance database 220. This allows for a user to review the technical requirements of each digitized contract and understand how that application or service is behaving on network 230. In certain embodiments, the results of the test cases and the associated test cases may be stored in a ML database or ML model (not shown). This allow the ML module to build test cases based on one or more digitized documents.

In some additional embodiments, automated payment modules 250 may access service level agreements in authoritative CTR governance database 220, and may automate invoices based on the terms and conditions listed in the service level agreements. For example, if there are deliverables, fees or credits identified in the contract, the platform kicks off payments based on the live network data.

In some embodiments, business intelligence dashboard 245 is configured to provide a live status of the contract deliverables, partner deliverables on network 230 and more to stakeholders.

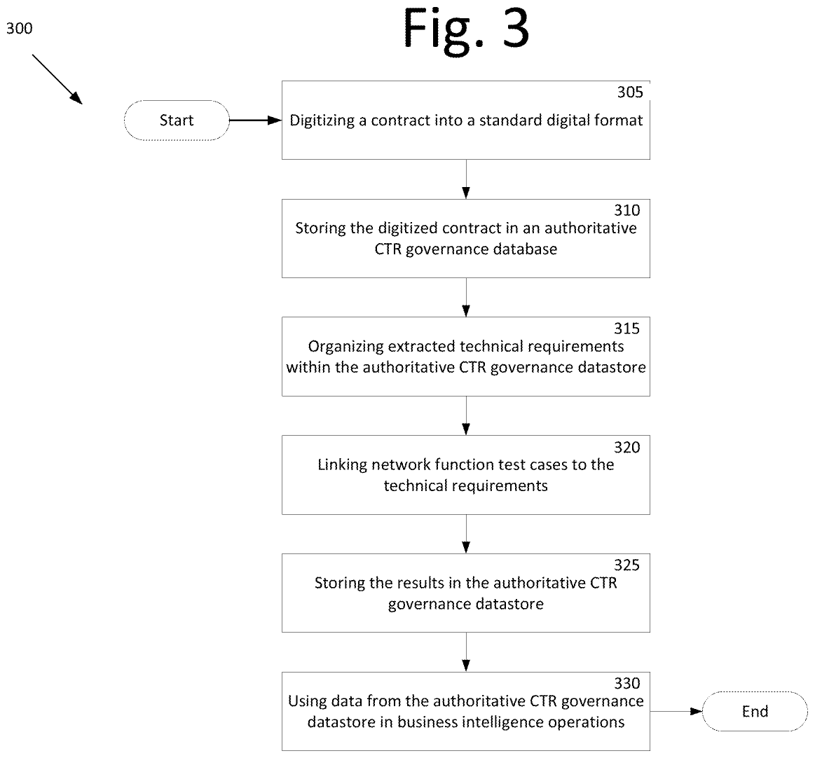

FIG. 3 is a flow diagram illustrating a method 300 for determining how a network should be operating or how the network should be deployed using a digitized document, according to an embodiment of the present invention. In some embodiments, method 300 includes digitizing a contract into a standard digital format, e.g., JSON format, at 305. At 310, the digitized contract is stored in an authoritative CTR governance datastore, and at 315, the technical requirements extract from the digitized contract are organized within the authoritative CTR governance datastore. At 320, network function test cases are linked to the technical requirements, which are organized in the authoritative CTR governance datastore. At 325, the results of the network testing are stored in the authoritative CTR governance datastore, and at 330, the data from the authoritative CTR governance datastore used in the business intelligence operations is received.

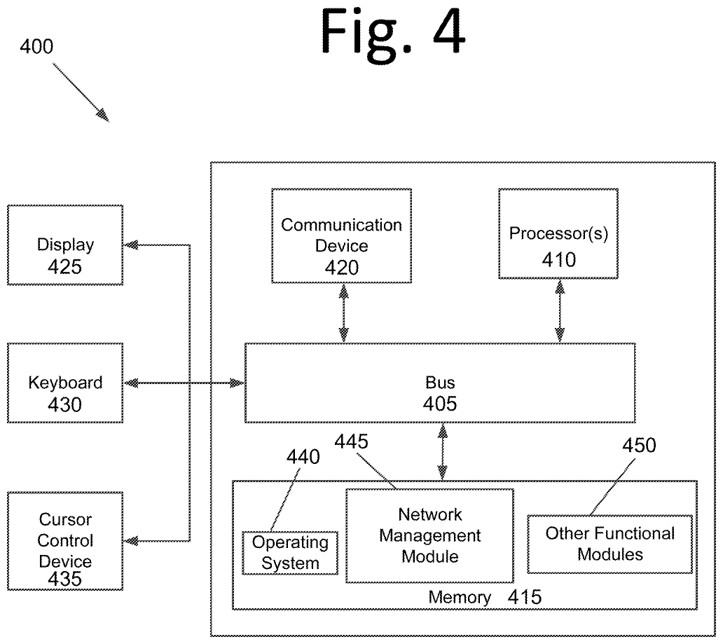

FIG. 4 is an architectural diagram illustrating a computing system 400 configured to digitize a document and test telecom network performance based on the digitized document, according to an embodiment of the present invention. In some embodiments, computing system 400 may be one or more of the computing systems depicted and/or described herein. Computing system 400 includes a bus 405 or other communication mechanism for communicating information, and processor(s) 410 coupled to bus 405 for processing information. Processor(s) 410 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 410 may also have multiple processing cores, and at least some of the cores may be configured to perform specific functions. Multi-parallel processing may be used in some embodiments. In certain embodiments, at least one of processor(s) 410 may be a neuromorphic circuit that includes processing elements that mimic biological neurons. In some embodiments, neuromorphic circuits may not require the typical components of a Von Neumann computing architecture.

Computing system 400 further includes a memory 415 for storing information and instructions to be executed by processor(s) 410. Memory 415 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 410 and may include volatile media, non-volatile media, or both. The media may also be removable, non-removable, or both.

Additionally, computing system 400 includes a communication device 420, such as a transceiver, to provide access to a communications network via a wireless and/or wired connection. In some embodiments, communication device 420 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 520 may include one or more antennas that are singular, arrayed, phased, switched, beamforming, beamsteering, a combination thereof, and or any other antenna configuration without deviating from the scope of the invention.

Processor(s) 410 are further coupled via bus 405 to a display 425, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 425 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 430 and a cursor control device 435, such as a computer mouse, a touchpad, etc., are further coupled to bus 405 to enable a user to interface with computing system 400. However, in certain embodiments, a physical keyboard and mouse may not be present, and the user may interact with the device solely through display 425 and/or a touchpad (not shown). Any type and combination of input devices may be used as a matter of design choice. In certain embodiments, no physical input device and/or display is present. For instance, the user may interact with computing system 400 remotely via another computing system in communication therewith, or computing system 400 may operate autonomously.

Memory 415 stores software modules that provide functionality when executed by processor(s) 410. The modules include an operating system 540 for computing system 400. The modules further include a network management module 445 that is configured to perform all or part of the processes described herein or derivatives thereof. Computing system 400 may include one or more additional functional modules 450 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIG. 3 may be performed by computer program(s), encoding instructions for the processor(s) to perform at least part of the process(es) described in FIG. 3, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 410 of computing system 400 of FIG. 4) to implement all or part of the process steps described in FIG. 4, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a computing system, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computing system, comprising:
memory storing computer program instructions; and
at least one processor configured to execute the computer program instructions, wherein the computer program instructions are configured to cause the at least one processor to:
digitizing a document into a standard digital format;
storing the digitized document in an authoritative CTR governance database;
organizing a plurality of technical requirements extracted from the digitized contract within the authoritative CTR governance database;
linking a plurality of network function test cases to the plurality of technical requirements; and
storing a plurality of results in the authoritative CTR governance database.

2. The computing system of claim 1, wherein the computer program instructions are configured to cause the at least one processor to:
using data from the authoritative CTR governance database in business intelligence operations.

3. The computing system of claim 1, wherein the computer program instructions are configured to cause the at least one processor to:
creating, by a code, a JSON file to digitize the document; and
uploading, by the code, of the JSON file into a tracking software, wherein the uploading of the JSON file comprises extracting data from the document.

4. The computing system of claim 1, wherein the computer program instructions are configured to cause the at least one processor to:
uploading, by a code embedded in a central repository, deliverables, technical specification and other information needed to be tracked; and
generating, by a project management module, unique IDs, wherein the unique IDS are associated with the deliverables, technical specification and other information; and

5. The computing system of claim 4, wherein the computer program instructions are configured to cause the at least one processor to:
updating, by the code, the JSON file with new information found in the document using the unique IDs.

6. The computing system of claim 4, wherein the computer program instructions are configured to cause the at least one processor to:
creating, by the code, a new JSON file with new information found in the document using the unique IDs.

7. The computing system of claim 1, wherein the computer program instructions are configured to cause the at least one processor to:
uploading a document via a user interface UI;
invoking a machine learning (ML) model upon uploading of the document;
automatically extract, by the ML model, the content from the document in a digitized format; and
uploading the extracted content in a project management module to be tracked.

8. The computing system of claim 7, wherein the computer program instructions are configured to cause the at least one processor to:
producing, by the ML model, the digitized document from the extracted content in JSON format.

9. A non-transitory computer-readable medium comprising a computer program, wherein the computer program is configured to cause at least one processor to execute:
digitizing a document into a standard digital format;
storing the digitized document in an authoritative CTR governance database;
organizing a plurality of technical requirements extracted from the digitized contract within the authoritative CTR governance database;
linking a plurality of network function test cases to the plurality of technical requirements; and
storing a plurality of results in the authoritative CTR governance database.

10. The non-transitory computer-readable medium of claim 9, wherein the computer program is further configured to cause at least one processor to execute:
using data from the authoritative CTR governance database in business intelligence operations.

11. The non-transitory computer-readable medium of claim 9, wherein the computer program is further configured to cause at least one processor to execute:
creating, by a code, a JSON file to digitize the document; and
uploading, by the code, of the JSON file into a tracking software, wherein the uploading of the JSON file comprises extracting data from the document.

12. The non-transitory computer-readable medium of claim 9, wherein the computer program is further configured to cause at least one processor to execute:
uploading, by a code embedded in a central repository, deliverables, technical specification and other information needed to be tracked; and
generating, by a project management module, unique IDs, wherein the unique IDS are associated with the deliverables, technical specification and other information; and

13. The non-transitory computer-readable medium of claim 12, wherein the computer program is further configured to cause at least one processor to execute:
updating, by the code, the JSON file with new information found in the document using the unique IDs.

14. The non-transitory computer-readable medium of claim 12, wherein the computer program is further configured to cause at least one processor to execute:
creating, by the code, a new JSON file with new information found in the document using the unique IDs.

15. The non-transitory computer-readable medium of claim 9, wherein the computer program is further configured to cause at least one processor to execute:
uploading a document via a user interface UI;
invoking a machine learning (ML) model upon uploading of the document;
automatically extract, by the ML model, the content from the document in a digitized format; and
uploading the extracted content in a project management module to be tracked.

16. The non-transitory computer-readable medium of claim 15, wherein the computer program is further configured to cause at least one processor to execute:
producing, by the ML model, the digitized document from the extracted content in JSON format.

17. A computer-implemented method, comprising:
digitizing a document into a standard digital format;
storing the digitized document in an authoritative CTR governance database;
organizing a plurality of technical requirements extracted from the digitized contract within the authoritative CTR governance database;
linking a plurality of network function test cases to the plurality of technical requirements; and
storing a plurality of results in the authoritative CTR governance database.

18. The computer-implemented method of claim 17, further comprising:
using data from the authoritative CTR governance database in business intelligence operations.

19. The computer-implemented method of claim 17, further comprising:
uploading, by a code embedded in a central repository, deliverables, technical specification and other information needed to be tracked; and
generating, by a project management module, unique IDs, wherein the unique IDS are associated with the deliverables, technical specification and other information; and

20. The computer-implemented method of claim 19, further comprising:
updating, by the code, the JSON file with new information found in the document using the unique IDs, or
creating, by the code, a new JSON file with new information found in the document using the unique IDs.

21. The computer-implemented method of claim 17, further comprising:
uploading a document via a user interface UI;
invoking a machine learning (ML) model upon uploading of the document;
automatically extract, by the ML model, the content from the document in a digitized format; and
uploading the extracted content in a project management module to be tracked.
